(19) United States
(12) Patent Application Publication
(10) Pub. No.: US 2009/0077031 A1
(43) Pub. Date: Mar. 19, 2009

(54) SYSTEM AND METHOD FOR CREATING FULL-TEXT INDEXES OF PATENT DOCUMENTS

(75) Inventors: CHUNG-I LEE, Tu-Cheng (TW); HAI-HONG LIN, Shenzhen (CN); DE-YI XIE, Shenzhen (CN); HAI-YUN CHEN, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/967,099

(22) Filed: Dec. 29, 2007

(30) Foreign Application Priority Data
Sep. 17, 2007 (CN) 200710201726.1

(51) Int. Cl. G06F 17/30

(52) U.S. Cl. 707/3; 707/E17.014

(57) ABSTRACT

A system for creating full-text indexes of patent documents includes a server and one or more computers. The server is connected with the one or more computers via a network. The server includes: a converting module is configured for converting the new patent document into a file in a predefined format, the file comprising multi-parts each corresponding to a part of the patent document; and a creating module is configured for appending the converted patent document to the database with a technique of creating full-text indexes and creating a full-text index for each part of all converted patent documents in the database. The method for creating full-text indexes of patent documents is also disclosed.

### BACKGROUND OF THE INVENTION

1. Field of the Invention

The present invention relates to a system and method for creating full-text indexes of patent documents.

2. Description of Related Art

The introduction and increasingly wide usage of computers in the past years has made heretofore unavailable information increasingly accessible. This information or data explosion has increased exponentially in the past decade with the advent of personal computers and the large scale linking of computers via local and wide area networks. As the amount of available data and information increases, for example, the patent documents, management and retrieval of that information about the patent documents has become an increasingly important and complex problem. An essential element to such management and retrieval is indexing. Indexing is a process of cataloging information in an efficient and coherent matter so that it can be easily accessed. Traditional indexing and retrieval schemes, however, are ill equipped to accommodate the creation of indexes which store linguistic, phonetic, contextual or other information about the words which are indexed. Consequently, the traditional indexing and retrieval may cost the users time and energy that causes a lot of inconvenience when the users collect data and search data.

What is needed, therefore, is a system and method for creating full-text indexes of patent documents that overcomes the above mentioned deficiencies.

### SUMMARY OF THE INVENTION

A system for creating full-text indexes of patent documents includes a server and one or more computers. The server is connected with the one or more computers via a network. The server includes: a converting module configured for converting a new patent document into a file in a predefined format, the file comprising multi-parts each corresponding to a part of the patent document; and a creating module configured for appending the converted patent document to the database with a technique of creating full-text indexes, and for creating a full-text index for each part of all converted patent documents in the database.

A method for creating full-text indexes of patent documents includes: reading a new patent document in a database; converting the new patent document into a file in a predefined format, the file comprising multi-parts each corresponding to a part of the patent document; appending the converted patent document to the database with a technique of creating full-text indexes; and creating a full-text index for each part of all converted patent documents in the database.

### BRIEF DESCRIPTION OF THE DRAWINGS

FIG. 1 is a schematic diagram of function module of a system for creating full-text indexes of patent documents in accordance with a preferred embodiment;

FIG. 2 is a flowchart of a preferred method for creating full-text indexes of patent documents in accordance with a preferred embodiment; and

FIG. 3 is a flowchart of searching patent documents based on the created full-text indexes in accordance with a preferred embodiment.

### DETAILED DESCRIPTION OF THE INVENTION

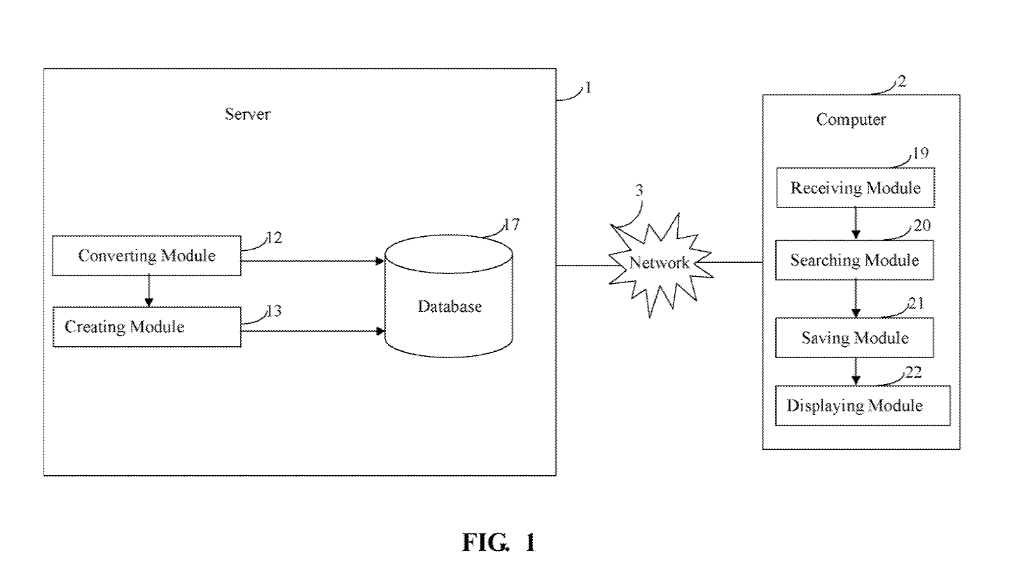

FIG. 1 is a schematic diagram of function module of a system for creating full-text indexes of patent documents in accordance with a preferred embodiment. The system typically includes a server 1 and one or more computers 2 (only one shown, hereinafter “the computer 2”). The server 1 connects with the computer 2 via a network 3. The server 1 may include a database 17, a converting module 12, and a creating module 13. The computer 2 may include a receiving module 19, a searching module 20, a saving module 21, and a displaying module 22.

Each patent document may be divided into various parts, each of which includes particular contents of a corresponding patent. For example, in this preferred embodiment, each patent document includes three parts: an abstract, a specification and claims. The specification may further include six sub-parts: a title, a field of the invention, description of related art, a summary of the invention, brief description of the drawings, and detailed description of the invention.

The converting module 12 is configured for converting a new patent document stored in the database 17 into a file in a predefined format. Specifically, the converting module 12 reads the new patent document from the database 17, for example, via File Transfer Protocol (FTP), reads each part of the new patent document, saves each part of the new patent document in the predefined format, and combines each part of the new patent document in the predefined format into a new file. The new file also includes multi-parts, each of which corresponds to a part of the patent document. That is to say, in this preferred embodiment, the new file in the predefined format may also include an abstract, a specification and claims. The new file in the predefined format (hereinafter “the converted patent document”) may be a Webpage file, an XML file, or a text file.

The creating module 13 is configured for appending the converted patent document to the database 17 with a technique of creating full-text indexes. The creating module 13 is also configured for creating a full-text index for each part of all converted patent documents in the database 17 by scanning each word of the converted patent document and pointing out each word location and frequency in each part of the converted patent document. The database 17 includes multi-fields, each of which corresponds to a part of the converted patent document, and stores contents and keywords of the corresponding part.

The receiving module 19 is configured for receiving one or more keywords inputted by a user when the user needs to search patent documents based on the created full-text indexes.

The searching module 20 is configured for searching in the database 17 for corresponding patent documents according to the one or more keywords to obtain brief information of the corresponding patent documents, and for calculating an association degree of each searched patent document. The brief information of each patent document may include a title, an abstract, and an application number of the patent document, etc. The association degree is a similitude degree (0˜1) between the keywords and each of the searched patent document.

The saving module 21 is configured for sequencing the searched patent documents according to the association degrees, and for saving the association degrees and the sequences in the database 17.

The displaying module 22 is configured for displaying the brief information of the searched patent documents according to the sequences, and for downloading or displaying full-text of a patent document selected by the user.

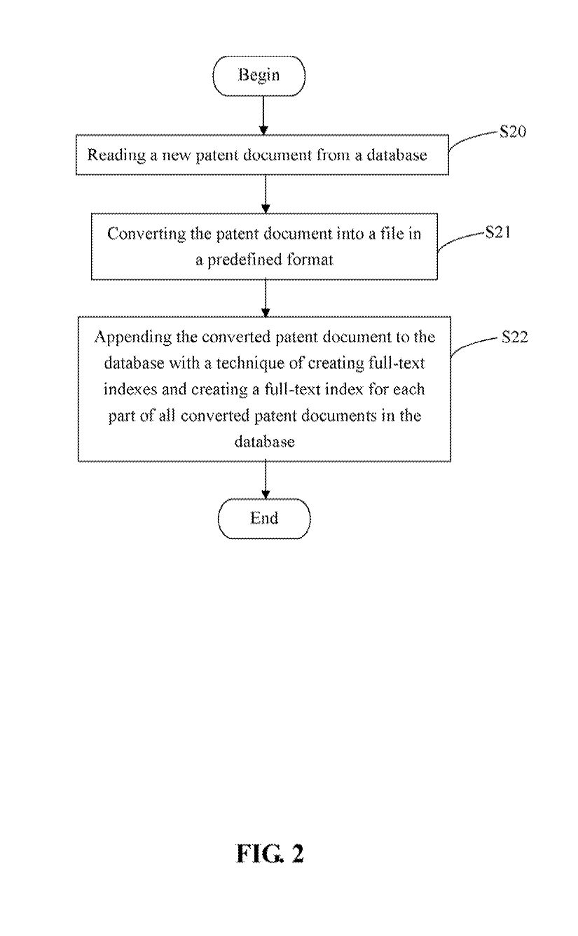

FIG. 2 is a flowchart of a preferred method for creating full-text indexes of patent documents in accordance with a preferred embodiment. In step S20, the converting module 12 reads a new patent document from the database 17, for example, via File Transfer Protocol (FTP). In step S21, the converting module 12 converts the new patent document into a file in a predefined format. Specifically, the converting module 12 reads each part of the new patent document, saves each part of the new patent document in the predefined format, and combines each part of the new patent document in the predefined format into a new file. In step S22, the creating module 13 appends the converted patent document to the database 17 with the technique of creating full-text indexes, and creates a full-text index for each part of all converted patent documents in the database 17. The database 17 includes multi-fields, each of which corresponds to a part of the converted patent document, and stores contents and keywords of the corresponding part.

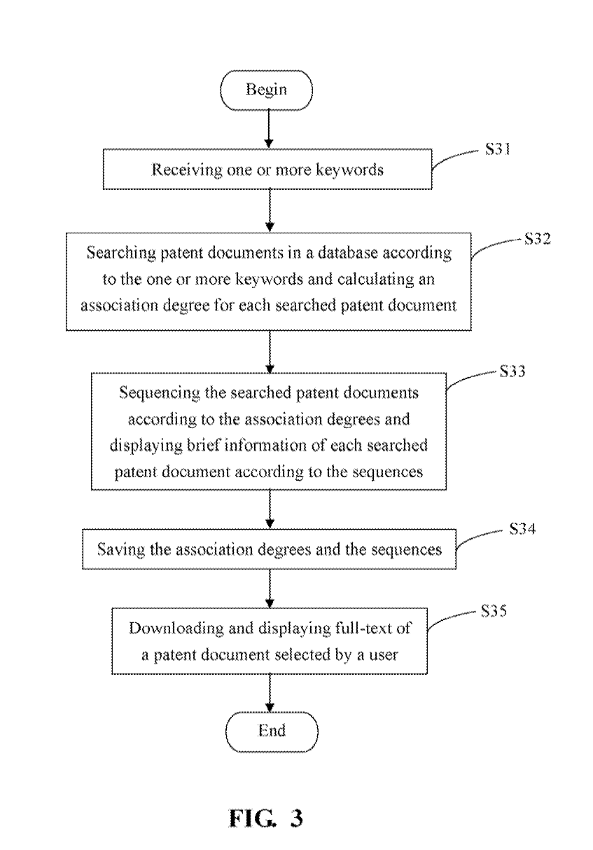

FIG. 3 is a flowchart of searching patent documents in the database 17 based on the created full-text indexes in accordance with a preferred embodiment. In step S31, the receiving module 19 receives one or more keywords inputted by a user when the user needs to search patents documents based on the created full-text indexes. In step S32, the searching module 20 searches in the database 17 for corresponding patent documents according to the one or more keywords to obtain brief information of the corresponding patent documents, and calculates an association degree of each searched patent document.

In step S33, the saving module 21 sequences the searched patent documents according to the association degrees, and the displaying module 22 displays the brief information of the searched patent documents according to the sequences.

In step S34, the saving module 21 saves the association degrees and the sequences in the database 17.

In step S35, the displaying module 22 downloads and displays full-text of a patent document selected by the user.

It is to be understood, however, that even though numerous characteristics and advantages of the indicated invention have been set forth in the foregoing description, together with details of the structure and function of the invention, the disclosure is illustrative only and changes may be made in details, especially in matters of shape, size and arrangement of parts within the principles of the invention to the full extent indicated by the broad general meaning of the terms in which the appended claims are expressed.

What is claimed is:

1. A system for creating full-text indexes of patent documents, the system comprising a server and one or more computers, the server being connected with the one or more computers via a network, the server comprising a converting module, a creating module, and a database, wherein:
the converting module is configured for converting a new patent document stored in the database into a file in a predefined format, the file comprising multi-parts each corresponding to a part of the patent document; and
the creating module is configured for appending the converted patent document to the database with a technique of creating full-text indexes, and for creating a full-text index for each part of all converted patent documents in the database.

2. The system of claim 1, wherein each of the one or more computers comprises:
a receiving module configured for receiving one or more keywords inputted by a user;
a searching module configured for searching in the database for corresponding patent documents according to the one or more keywords to obtain brief information of the corresponding patent documents, and for calculating an association degree of each searched patent document, the association degree being a similitude degree between the keywords and each searched patent document;
a saving module configured for sequencing the searched patent documents according to the association degrees, and for saving the association degrees and the sequences in the database; and
a displaying module configured for displaying the brief information of the searched patent documents according to the sequences, and for displaying full-text of a searched patent document selected by the user.

3. The system of claim 1, wherein:
the predefined format is selective to be a Webpage file, an XML file, or a text file.

4. A method for creating full-text indexes of patent documents, the method comprising:
reading a new patent document in a database;
converting the new patent document into a file in a predefined format, the file comprising multi-parts each corresponding to a part of the patent document;
appending the converted patent document to the database with a technique of creating full-text indexes; and
creating a full-text index for each part of all converted patent documents in the database.

5. The method of claim 4, further comprising a step of searching patent documents in the database based on the created full-text indexes, the searching step comprising:
receiving one or more keywords inputted by a user;
searching in the database for corresponding patent documents according to the one or more keywords to obtain brief information of the corresponding patent documents, and calculating an association degree of each searched patent document and the keywords;
sequencing the searched patent documents according to respective association degrees;
saving the association degrees and the sequences in the database;
displaying the brief information of the searched patent documents according to the sequences; and
displaying full-text of a patent document selected by the user.

6. The method of claim 4, wherein: the predefined format is selective to be a Webpage file, an XML file, or a text file.
